(19) United States
(12) Patent Application Publication
(10) Pub. No.: US 2015/0112992 A1
(43) Pub. Date: Apr. 23, 2015

(54) METHOD FOR CLASSIFYING CONTENTS AND ELECTRONIC DEVICE THEREOF

(71) Applicant: Samsung Electronics Co., Ltd., Gyeonggi-do (KR)

(72) Inventors: Ki-Huk LEE, Gyeonggi-do (KR); Moon-Soo KIM, Seoul (KR); Hyun-Jung KIM, Seoul (KR)

(21) Appl. No.: 14/449,588

(22) Filed: Aug. 1, 2014

(30) Foreign Application Priority Data
Oct. 18, 2013 (KR) 10-2013-0124821

(51) Int. Cl. G06F 17/30

(52) U.S. Cl. CPC G06F 17/3097; G06F 17/30705
USPC 707/737

(57) ABSTRACT

An electronic device and method for classifying contents using updated post information are provided. The electronic device may be configured to implement the method, and includes a communication module configured to upload to a server at least one content item, and receive from the server a set of information about at least one content item from a server. A processor of the electronic device may be configured to extract a subset of information associated with the at least one content item from the set of information, the subset including at least one reference value, and classify the at least one content item with other content items when the at least one reference value correlates with reference values of the other content items.

### CLAIM OF PRIORITY

This application claims priority under 35 U.S.C. §119(a) to a Korean Patent Application filed in the Korean Intellectual Property Office on Oct. 18, 2013 and assigned Serial No. 10-2013-0124821, the contents of which are herein incorporated by reference.

### TECHNICAL FIELD

The present disclosure relates to a method for managing data, and, more particularly to a method for classifying contents and an electronic device thereof.

### BACKGROUND

In general, electronic devices generate tagging information concurrently when generating content, and store the tagging information in the generated content together. For example, for a captured image, electronic devices may record location information indicating where an image is taken, and time information indicating when the image was taken. This location and time information may be stored within data fields of the image.

Accordingly, electronic devices may classify the stored contents using the tagging information stored in content in accordance to a method desired by a user.

### SUMMARY

Various example embodiments of the present disclosure are to provide an apparatus and method capable of improving a user's convenience by efficiently classifying a plurality of contents using updated post information.

Various example embodiments of the present disclosure are to provide an apparatus and method capable of approaching even an emotional portion by extracting a word expressing a human's emotion among updated post information and utilizing the extracted word when classifying stored contents.

According to example embodiments of the present disclosure, an operation method of an electronic device is provided. The method includes uploading to a server at least one content item, receiving from the server a set of information associated with the at least one content item, extracting a subset of information associated with the at least one content item from the set of information, the subset including at least one reference value, and classifying the at least one content item with other content items when the at least one reference value correlates with reference values of the other content items.

According to example embodiments of the present disclosure, an operation method of a server is provided. The method includes receiving upload of at least one content item and supplementary information about the content item from a first electronic device, receiving an update of the received supplementary information from at least one second electronic device, and transmitting the updated supplementary information to the first electronic device, wherein the first electronic device is configured to extract a subset of information from the updated supplementary information, and classify the at least one content item with other content items stored on the first electronic device when at least one reference value of the subset correlates with reference values of the other content items.

According to example embodiments of the present disclosure, an electronic device includes a communication module and a processor. The communication module is configured to upload to a server at least one content item, and receive from the server a set of information about at least one content item from a server. The processor is configured to extract a subset of information associated with the at least one content item from the set of information, the subset including at least one reference value, and classify the at least one content item with other content items when the at least one reference value correlates with reference values of the other content items.

According to example embodiments of the present disclosure, a server includes a communication unit and a processor. The processor is configured to receive, via the communication unit, upload of at least one content item and supplementary information about the content item from a first electronic device, receive, via the communication unit, an update of the received supplementary information from at least one second electronic device, and transmit, via the communication unit, the updated supplementary information to the first electronic device, wherein the first electronic device is configured to extract a subset of information from the updated supplementary information, and classify the at least one content item with other content items stored on the first electronic device when at least one reference value of the subset correlates with reference values of the other content items.

### BRIEF DESCRIPTION OF THE DRAWINGS

The present disclosure will become more apparent from the following detailed description when taken in conjunction with the accompanying drawings in which:

FIG. 1 is a block diagram illustrating an implementation of an electronic device according to one example embodiment of the present disclosure;

FIG. 2 is a block diagram illustrating an implementation of hardware according to one example embodiment of the present disclosure;

FIG. 3 is a block diagram illustrating an implementation of a programming module according to one example embodiment of the present disclosure;

FIG. 4 is a block diagram schematically illustrating an implementation of an electronic device interworking with a server according to the present disclosure;

FIG. 5 is a block diagram illustrating an implementation of a server according to one example embodiment of the present disclosure;

FIG. 6 is a diagram illustrating one example embodiment of extracting second subset of information about contents based on first set of information received from a server in an electronic device according to the present disclosure;

FIG. 7 is a diagram illustrating one example embodiment of classifying contents in accordance to a set reference based on extracted second subset of information in an electronic device according to the present disclosure;

FIG. 8 is a flowchart illustrating an operation method of an electronic device of classifying contents using updated post information according to one example embodiment of the present disclosure;

FIG. 9 is a flowchart illustrating an operation method of a server according to one example embodiment of the present disclosure;

FIG. 10 is a flowchart illustrating a method of an electronic device according to one example embodiment of the present disclosure;

FIG. 11 is a flowchart illustrating a method of a server according to one example embodiment of the present disclosure; and

FIG. 12 is a diagram schematically illustrating an implementation of an electronic device according to one example embodiment of the present disclosure.

### DETAILED DESCRIPTION

The present disclosure is described below with reference to the accompanying drawings. The present disclosure exemplifies specific example embodiments in the drawings and states a related detailed description, but can make various modifications and can have several example embodiments. Accordingly, it should be understood that the present disclosure does not intend to be limited to a specific embodiment form, and includes all modifications or equivalents or substitutes included in the ambit of the present disclosure. In relation to a description of the drawing, like reference symbols denote like constituent elements.

An electronic device according to the present disclosure can be a device including a telecommunication function. For example, the electronic device can be one or more combinations of various electronic devices such as a smart phone, a tablet Personal Computer (PC), a mobile phone, a video phone, an electronic book (e-book) reader, a desktop PC, a laptop PC, a netbook computer, a Personal Digital Assistant (PDA), a Portable Multimedia Player (PMP), an MPEG Audio Layer 3 (MP3) player, a mobile medical instrument, an electronic bracelet, an electronic necklace, an electronic accessory, a camera, a wearable device, an electronic clock, a wrist watch, a smart home appliance (e.g., a refrigerator, an air conditioner, a cleaner, an artificial intelligence robot, a TV, a Digital Video Disk (DVD) player, an audio system, an oven, a microwave, a washing machine, an air cleaner, an electronic frame, and the like), various medical instruments (e.g., Magnetic Resonance Angiography (MRA), Magnetic Resonance Imaging (MRI), Computerized Tomography (CT), a moving-camera, an ultrasound machine and the like), a navigation device, a Global Positioning System (GPS) receiver, an Event Data Recorder (EDR), a Flight Data Recorder (FDR), a set-top box, a TV box (for example, Samsung HomeSync™, AppleTV™, or Google TV™), an electronic dictionary, a car infotainment device, an electronic equipment for ship (for example, a navigation device for ship, a gyrocompass and the like), avionics, a security instrument, electronic clothes, an electronic locking system, a camcorder, a game console, a Head-Mounted Display (HMD), a flat panel display device, an electronic album, part of a furniture or building/structure including a telecommunication function, an electronic board, an electronic signature receiving device, a projector, and the like. It is apparent to those skilled in the art that the electronic device according to the present disclosure is limited to the aforementioned instruments.

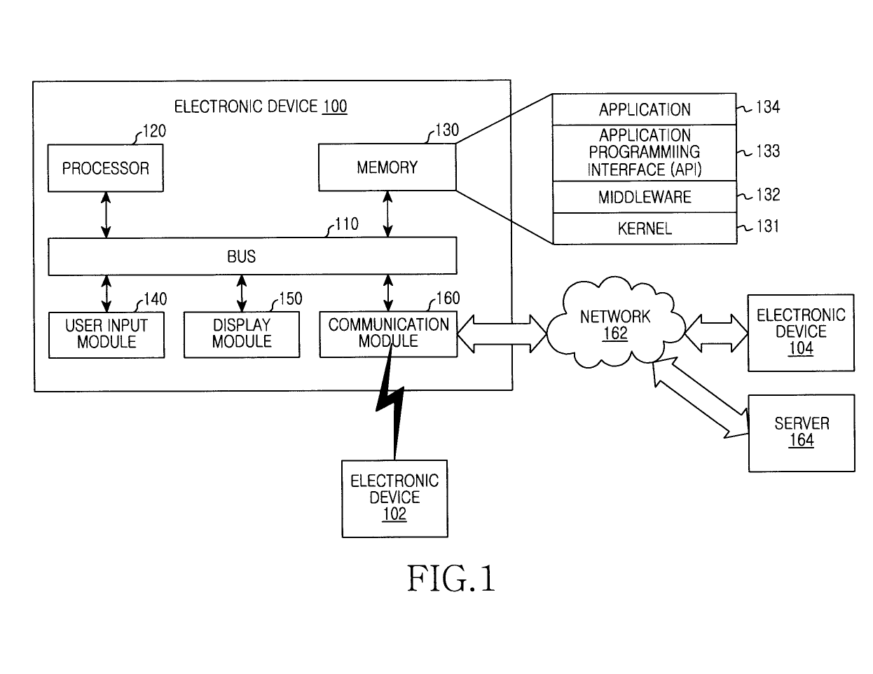

FIG. 1 is a block diagram illustrating an implementation of an electronic device according to one example embodiment of the present disclosure. Referring to FIG. 1, the electronic device 100 can include a bus 110, a processor 120, a memory 130, a user input module 140, a display module 150, and a communication module 160.

The bus 110 can be a circuit connecting the aforementioned constituent elements with one another, and relaying communication (e.g., control message) between the aforementioned constituent elements.

The processor 120 can, for example, receive instructions from the aforementioned other constituent elements (e.g., the memory 130, the user input module 140, the display module 150, the communication module 160, and the like) through the bus 110, decipher the received instructions, and execute operation or data processing according to the deciphered instructions.

The memory 130 can store an instruction or data which is received from the processor 120 or the other constituent elements (e.g., the user input module 140, the display module 150, the communication module 160, and the like) or is generated by the processor 120 or the other constituent elements. The memory 130 can include, for example, programming modules such as a kernel 131, a middleware 132, an Application Programming Interface (API) 133, applications 134 and the like. The aforementioned respective programming modules include software, firmware, hardware or a combination of at least two or more of them.

The kernel 131 can control or manage system resources (e.g., the bus 110, the processor 120, the memory 130 and the like) used for executing operations or functions implemented in the remnant other programming modules, for example, the middleware 132, the API 133, and the applications 134. Also, the kernel 131 can provide an interface of enabling the middleware 132, the API 133, or the applications 134 to access and control or manage the individual constituent element of the electronic device 100.

The middleware 132 can perform a relay role of enabling the API 133 or the applications 134 to communicate and exchange data with the kernel 131. Also, in relation with work requests received from the (plurality of) applications 134, the middleware 132 can, for example, perform load balancing for the work request using a method of allotting at least one application among the (plurality of) applications 134 the order of priority capable of using the system resources (e.g., the bus 110, the processor 120, the memory 130 or the like) of the electronic device 100 and the like.

The API 133 is an interface of enabling the applications 134 to control a function provided by the kernel 131 or the middleware 132. The API 133 can include, for example, at least one interface or function for file control, window control, image processing, character control or the like.

The user input module 140 can, for example, receive an input of an instruction or data from a user and forward the instruction or data to the processor 120 or the memory 130 through the bus 110. The display module 150 can display an image, a video, data or the like to the user.

The communication module 160 can connect communication between the electronic device 100 and other electronic device 102. The communication module 160 can support a certain short-range communication protocol (e.g., Wireless Fidelity (WiFi), Bluetooth (BT), or Near Field Communication (NFC)), and certain network communication 162 (e.g., the Internet, a Local Area Network (LAN), a Wide Area Network (WAN), a telecommunication network, a cellular network, a satellite network, a Plain Old Telephone System (POTS) or the like). The electronic devices 102 and 104 each can be the same (e.g., same-type) device as the electronic device 100 or can be a different (e.g., different-type) device.

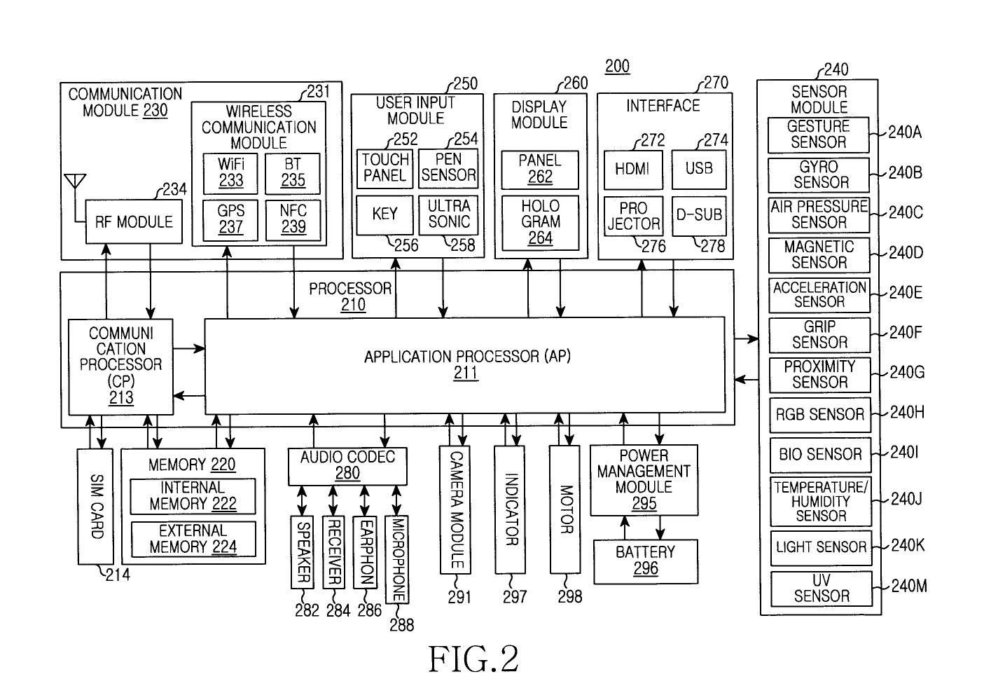

FIG. 2 is a block diagram illustrating an implementation of hardware according to one example embodiment of the present disclosure. The hardware 200 can be, for example, the electronic device 100 illustrated in FIG. 1. Referring to FIG. 2, the hardware 200 include one or more processors 210, a Subscriber Identification Module (SIM) card 214, a memory 220, a communication module 230, a sensor module 240, a user input module 250, a display module 260, an interface 270, an audio codec 280, a camera module 291, a power management module 295, a battery 296, an indicator 297, or a motor 298.

The processor 210 (e.g., the processor 120) can include one or more Application Processors (APs) 211 or one or more Communication Processors (CPs) 213. The processor 210 can be, for example, the processor 120 illustrated in FIG. 1. Although FIG. 2 illustrates that the AP 211 and the CP 213 are included within the processor 210, the AP 211 and the CP 213 can be included within different IC packages, respectively. In one example embodiment, the AP 211 and the CP 213 can be included within one IC package. In the present disclosure, the processor 210 can extract second subset of information about contents based on received first set of information, and classify the contents in accordance to a set reference based on the extracted second subset of information. Also, the processor 210 can compare the received first set of information and supplementary information about the contents uploaded together with the contents to a server and, if a data capacity of the first set of information is greater a set capacity than a data capacity of the supplementary information, the processor 210 can confirm at least one information among the number of times of recommendation of the contents, the number of times of sharing, the number of times of comment, a set keyword among comment content, the number of times of additional information request, and the number of times of additional information provision extracted from the first set of information, and can extract the confirmed at least one information in a metadata form. Also, the processor 210 can store the extracted second subset of information in the contents, respectively, and confirm the second subset of information stored in the respective contents, and classify the respective contents into any one contents group storing contents of similarity equal to or greater than set information with the confirmed second subset of information among at least one contents group. Also, the processor 210 can detect at least one content of which the second subset of information is updated equal to or greater than a set capacity among the classified plurality of contents, and choose the detected content as representative content of a contents group in which the contents are stored.

The AP 211 can drive an operating system or an application program and control a plurality of hardware or software constituent elements connected to the AP 211, and perform processing and operations of various data including multimedia data. The AP 211 can be, for example, implemented as a System on Chip (SoC). According to one example embodiment, the processor 210 can further include a Graphic Processing Unit (GPU) (not shown).

The CP 213 can perform a function of managing a data link and converting a communication protocol in a communication between an electronic device (e.g., the electronic device 100) including the hardware 200 and other electronic devices connected through a network 162. The CP 213 can be implemented as a SoC, for example. According to one example embodiment, the CP 213 can perform at least part of a multimedia control function. The CP 213 can perform terminal distinction and authentication within a communication network, using a subscriber identity module (e.g., the SIM card 214). Also, the CP 213 can provide services such as voice telephony, video telephony, a text message, packet data or the like to a user.

Also, the CP 213 can control data transmission/reception of the communication module 230. Although FIG. 2 illustrates the constituent elements such as the CP 213, the power management module 295, the memory 220 and the like as constituent elements separate from the AP 211, according to one example embodiment, the AP 211 can be implemented to include at least some (e.g., the CP 213) of the aforementioned constituent elements.

According to one example embodiment, the AP 211 or the CP 213 can load to a volatile memory an instruction or data received from a non-volatile memory connected to each of the AP 211 and the CP 213 or at least one of other constituent elements, and process the loaded instruction or data. Also, the AP 211 or the CP 213 can store in the non-volatile memory data received from at least one of the other constituent elements or generated by at least one of the other constituent elements.

The SIM card 214 can be a card implementing the subscriber identity module, and can be inserted into a slot provided in a specific location of the electronic device. The SIM card 214 can include unique identification information (e.g., Integrated Circuit Card ID (ICCID)) or subscriber information (e.g., International Mobile Subscriber Identity (IMSI)).

The memory 220 can include an internal memory 222 or an external memory 224. The memory 220 can be, for example, the memory 130 illustrated in FIG. 1. The internal memory 222 can include, for example, at least one of a volatile memory (e.g., a Dynamic Random Access Memory (DRAM), a Static Random Access Memory (SRAM), a Synchronous Dynamic Random Access Memory (SDRAM) and the like) or a non-volatile memory (e.g., a One Time PROM (OTPROM), a Programmable ROM (PROM), an Erasable Programmable ROM (EPROM), an Electrically Erasable Programmable ROM (EEPROM), a mask Read Only Memory (ROM), a flash ROM, a Not AND (NAND) flash memory, a Not OR (NOR) flash memory and the like). According to one example embodiment, the internal memory 222 can take a form of Solid State Drive (SSD). The external memory 224 can further include, for example, Compact Flash (CF), Secure Digital (SD), Micro Secure Digital (Micro-SD), Mini Secure Digital (Mini-SD), extreme Digital (xD), a memory stick or the like.

The communication module 230 can include a wireless communication module 231 or a Radio Frequency (RF) module 234. The communication module 230 can be, for example, the communication module 160 illustrated in FIG. 1. The wireless communication module 231 can include, for example, WiFi 233, BT 235, GPS 237 and NFC 239. For example, the wireless communication module 231 can provide a wireless communication function using radio frequency. Additionally or alternatively, the wireless communication module 231 can include a network interface (e.g., a LAN card), a modem or the like for connecting the hardware 200 with a network (e.g., the Internet, a LAN, a WAN, a telecommunication network, a cellular network, a satellite network, a POTS or the like). In the present disclosure, the communication module 230 can receive first set of information about at least one content from the server, and upload the content and supplementary information about the content to the server.

The RF module 234 can take charge of transmission/reception of data, for example, transmission/reception of an RF signal or a called electric signal. The RF module 234 can include, though not illustrated, for example, a transceiver, a Power Amp Module (PAM), a frequency filter, a Low Noise Amplifier (LNA) or the like. Also, the RF module 234 can further include a component for transmitting/receiving an electromagnetic wave on a free space in a wireless communication, for example, a conductor, a conductive line or the like.

The sensor module 240 can include, for example, at least one of a gesture sensor 240A, a gyro sensor 240B, an air pressure sensor 240C, a magnetic sensor 240D, an acceleration sensor 240E, a grip sensor 240F, a proximity sensor 240G, a Red Green Blue (RGB) sensor 240H, a biological sensor 240I, a temperature/humidity sensor 240J, a light sensor 240K, or a Ultraviolet (UV) sensor 240M. The sensor module 240 can measure a physical quantity or sense an activation state of the electronic device and convert the measured or sensed information into an electrical signal. Additionally or alternatively, the sensor module 240 can include, for example, an Electronic nose (E-nose) sensor (not shown), an Electromyography (EMG) sensor (not shown), an Electroencephalogram (EEG) sensor (not shown), an Electrocardiogram (ECG) sensor (not shown), a fingerprint sensor (not shown) or the like. The sensor module 240 can further include a control circuit for controlling at least one or more sensors provided therein.

The user input module 250 can include a touch panel 252, a (digital) pen sensor 254, a key 256, or an ultrasonic input device 258. The user input module 250 can be, for example, the user input module 140 illustrated in FIG. 1. The touch panel 252 can recognize, for example, a touch input in at least one method among a capacitive method, a pressure sensitive method, an infrared method, and an ultrasonic method. Also, the touch panel 252 may further include a controller (not shown). In the capacitive method, proximity recognition as well as direct touch is possible. The touch panel 252 may further include a tactile layer. In this case, the touch panel 252 can provide a tactile response to a user.

The (digital) pen sensor 254 can be implemented, for example, using the same or similar method to receiving a user's touch input or a separate recognizing sheet. The key 256 can be, for example, a keypad or a touch key. The ultrasonic input device 258 is a device capable of confirming data by sensing a sound wave with a microphone (e.g., a microphone 288) of the electronic device, and can perform wireless recognition through a pen generating an ultrasonic signal. According to one example embodiment, the hardware 200 may receive a user input from an external device (e.g., a network, a computer, or a server) connected to the hardware 200 using the communication module 230.

The display module 260 can include a panel 262 or a hologram 264. The display module 260 can be, for example, the display module 150 illustrated in FIG. 1. The panel 262 can be, for example, a Liquid Crystal Display (LCD), an Active-Matrix Organic Light-Emitting Diode (AMOLED), or the like. The panel 262 can be implemented to be flexible, transparent, or wearable, for example. The panel 262 may be implemented as one module together with the touch panel 252. The hologram 264 can show a three-dimensional image in the air by using interference of light. According to one example embodiment, the display module 260 can further include a control circuit for controlling the panel 262 or the hologram 264.

The interface 270 can include, for example, a High-Definition Multimedia Interface (HDMI) 272, a Universal Serial Bus (USB) 274, a projector 276, or a D-subminiature (D-sub) 278. Additionally or alternatively, the interface 270 can include, for example, Secure Digital/Multi Media Card (SD/MMC) (not shown), or Infrared Data Association (IrDA) (not shown).

The audio codec 280 can convert a voice and an electric signal interactively. The audio codec 280 can convert, for example, voice information that is inputted or outputted through a speaker 282, a receiver 284, an earphone 286, the microphone 288, or the like.

The camera module 291 is a device capable of taking a picture and a video. According to one example embodiment, the camera module 291 can include one or more image sensors (e.g., front lenses or rear lenses), an Image Signal Processor (ISP) (not shown), or a flash LED (not shown).

The power management module 295 can manage power of the hardware 200. Though not illustrated, the power management module 295 can include, for example, a Power Management Integrated Circuit (PMIC), a charger Integrated Circuit (IC), and a battery gauge.

The PMIC can be mounted, for example, within an integrated circuit or a SoC semiconductor. A charging method can be divided into wired and wireless. The charger IC can charge a battery, and can prevent the inflow of overvoltage or overcurrent from an electric charger. According to one example embodiment, the charger IC can include a charger IC for at least one of a wired charging method or a wireless charging method. As the wireless charging method, there are a magnetic resonance method, a magnetic induction method, an electromagnetic method and the like, for example. The charger IC can be added with supplementary circuits for wireless charging, for example, a coil loop, a resonance circuit, a rectifier circuit and the like.

The battery gauge can measure, for example, a level of the battery 296, a charging voltage thereof, an electric current thereof, or a temperature thereof. The battery 296 can generate electricity and supply a power source. The battery 296 can be, for example, a rechargeable cell.

The indicator 297 can display a specific state of the hardware 200 or a part (e.g., the AP 211) thereof, for example, a booting state, a message state, a charging state or the like. The motor 298 can convert an electrical signal into a mechanical vibration. Though not illustrated, the hardware 200 can include a processing device (e.g., a GPU) for mobile TV support. The processing device for mobile TV support can process, for example, media data of Digital Multimedia Broadcasting (DMB), Digital Video Broadcasting (DVB), a media flow or the like.

The names of the aforementioned constituent elements of the hardware 200 according to the present disclosure can be varied according to the kind of the hardware 200. The hardware according to the present disclosure can include at least one of the aforementioned constituent elements, and can omit some constituent elements or further include additional other constituent elements. Also, some of the constituent elements of the hardware 200 according to the present disclosure are coupled and implemented as one entity, thereby being able to identically perform the functions of the corresponding constituent elements of before being coupled.

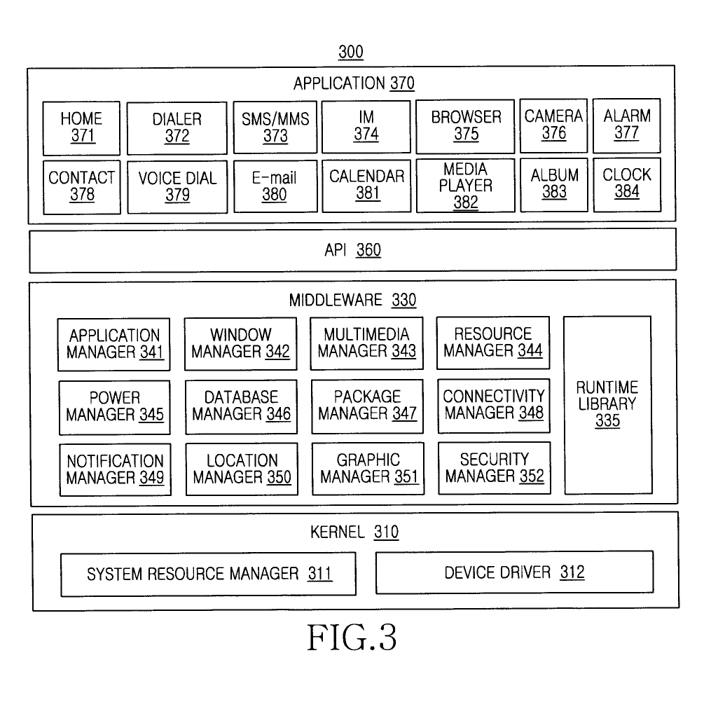

FIG. 3 is a block diagram illustrating an implementation of a programming module according to one example embodiment of the present disclosure. The programming module 300 can be included (e.g., stored) in the electronic device 100 (e.g., the memory 130) illustrated in FIG. 1. At least part of the programming module 300 can be implemented by software, firmware, hardware, or a combination of at least two or more of them. The programming module 300 can include an Operating System (OS) implemented in hardware (e.g., the hardware 200) and controlling resources related to the electronic device (e.g., the electronic device 100) or various applications (e.g., the application 370) driven on the operating system. For example, the operating system can be Android, iPhone OS (iOS), Windows, Symbian, Tizen, Badda, or the like. Referring to FIG. 3, the programming module 300 can include a kernel 310, a middleware 330, an API 360, or an application 370.

The kernel 310 (e.g., the kernel 131) can include a system resource manager 311 or a device driver 312. The system resource manager 311 can include, for example, a process management unit (not shown), a memory management unit (not shown), a file system management unit (not shown), or the like. The system resource manager 311 can perform control of a system resource, allocation thereof, recovery thereof, or the like. The device driver 312 can include, for example, a display driver (not shown), a camera driver (not shown), a Bluetooth driver (not shown), a shared memory driver (not shown), a USB driver (not shown), a keypad driver (not shown), a WiFi driver (not shown), or an audio driver (not shown). Also, according to one example embodiment, the device driver 312 can include an Inter-Process Communication (IPC) driver (not shown).

The middleware 330 can include a plurality of modules previously implemented to provide a function commonly implemented by the application 370. Also, the middleware 330 can provide a function through the API 360 such that the application 370 can make efficient use of a restricted system resource within the electronic device. For example, as illustrated in FIG. 3, the middleware 330 (e.g., the middleware 132) can include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 can include, for example, a library module that a compiler uses to add a new function through a programming language while the application 370 is run. According to one example embodiment, the runtime library 335 can perform a function and the like for input/output, memory management or arithmetic function.

The application manager 341 can manage, for example, a life cycle of at least one application among the applications 370. The window manager 342 can manage a GUI resource used in a screen. The multimedia manager 343 can grasp a format for playing various media files, and perform encoding or decoding of a media file using a codec adapted to a corresponding format. The resource manager 344 can manage a resource such as a source code of at least any one application among the applications 370, a memory thereof, a storage space thereof, or the like.

The power manager 345 can operate together with a Basic Input/Output System (BIOS) and the like to manage a battery or power source, and provide power information and the like for the operation. The database manager 346 can manage to create, search or change a database to be used in at least one application among the applications 370. The package manager 347 can manage installation or updating of an application which is distributed in a form of a package file.

The connectivity manager 348 can manage, for example, wireless connection such as WiFi, Bluetooth or the like. The notification manager 349 can display or notify an event such as an arrival message, an appointment, a proximity notification and the like in a way not giving a disturbance to a user. The location manager 350 can manage location information of the electronic device. The graphic manager 351 can manage a graphic effect to be provided to the user or a user interface related to this. The security manager 352 can provide a general security function for system security, user authentication or the like. According to one example embodiment, if the electronic device (e.g., the electronic device 100) has a phone function, the middleware 330 can further include a telephony manager (not shown) for managing a voice or video telephony function of the electronic device.

The middleware 330 can create and use a new middleware module through a combination of various functions of the aforementioned internal constituent element modules. The middleware 330 can provide a module specialized by kind of an operating system so as to provide a differentiated function. Also, the middleware 330 can dynamically delete some of the existing constituent elements or add new constituent elements. Accordingly, the middleware 330 can omit some of the constituent elements stated in an example embodiment of the present disclosure or further include or substitute other constituent elements with constituent elements of different names performing similar functions.

The API 360 (e.g., the API 133) is a set of API programming functions, and can be provided to have a different implementation in accordance to an operating system. For example, in a case of Android or iOS, it can provide, for example, one API set by platform and, in a case of Tizen, it can provide, for example, two or more API sets.

The applications 370 (e.g., the applications 134) can include, for example, a preloaded application or a third party application.

At least part of the programming module 300 can be implemented by an instruction stored in a computer-readable storage medium. When the instruction is executed by one or more processors (e.g., the processor 210), the one or more processors can perform a function corresponding to the instruction. The computer-readable storage medium can be, for example, the memory 220. At least part of the programming module 300 can be implemented (e.g., executed), for example, by the processor 210. At least part of the programming module 300 can include, for example, a module, a program, a routine, an instruction set, a process or the like for performing one or more functions.

The names of the constituent elements of the programming module (e.g., the programming module 300) according to the present disclosure can be varied in accordance to the kind of an operating system. Also, the programming module according to the present disclosure can include at least one or more of the aforementioned constituent elements, omit some of the aforementioned constituent elements, or further include additionally other constituent elements.

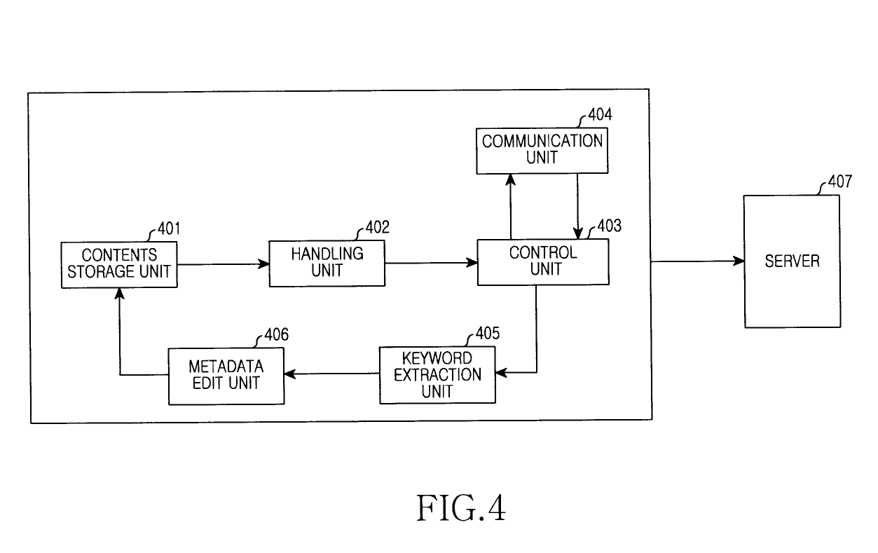

FIG. 4 is a block diagram schematically illustrating an implementation of an electronic device interworking with a server according to the present disclosure. As illustrated in FIG. 4, the electronic device according to the present disclosure can include a contents storage unit 401, a handling unit 402, a control unit 403, a communication unit 404, a keyword extraction unit 405, and a metadata editing unit 406.

First, the contents storage unit 401 stores the original contents to be shared with a third party and tag information. In detail, the contents storage unit 401 stores an image and video to be shared with the third party. Each of the image and video includes tag information, respectively. For example, the respective contents stored in the contents storage unit 401 include place information, time information and the like of those times when the contents are photographed.

The handling unit 402 can select at least one content among a plurality of contents stored in the contents storage unit 401 in accordance to user's selection, and receive an input of a composition of posts related with the selected content, and receive an input of an instruction of uploading the composed posts to a specific server 407.

The control unit 403 confirms content selected by the handling unit 402 and a server to upload the selected content, and transmits the selected content and user information to the communication unit 404, and controls the communication unit 404 to receive updated information about posts.

The communication unit 404 accesses the server 407 providing a sharing service, and transmits data provided by the control unit 403 to the server 407, and receives provided data from the server 407.

The keyword extraction unit 405 extracts set data from updated post information provided by the server 407, and converts the extracted data into a form suitable to a keyword.

The metadata editing unit 406 generates and stores a keyword extracted from the keyword extraction unit 405 in tag information of designated contents.

In the aforementioned block implementation, the control unit 403 can perform the general function of the electronic device. Separately implementing and illustrating these are for distinguishing and describing respective functions. Accordingly, when product is actually implemented, the product can be implemented such that the control unit 403 processes all of the functions of the electronic device, or can be implemented such that the control unit 403 processes some of the functions.

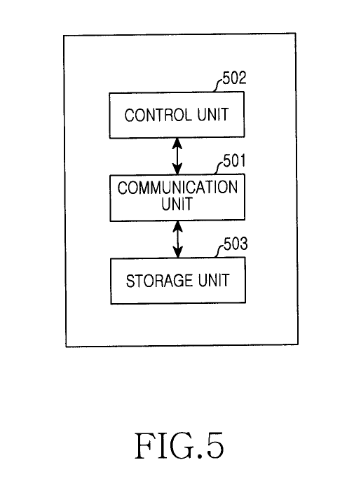

FIG. 5 is a block diagram illustrating an implementation of a server according to one example embodiment of the present disclosure. As illustrated in FIG. 5, the server according to the present disclosure can include a control unit 501, a communication unit 502, and a storage unit 503.

First, the control unit 501 controls the general operation of the server. For example, the control unit 501 confirms that supplementary information about received contents is updated from at least one second subset of electronic device.

The communication unit 502 processes a signal transmitted/received through an antenna for the sake of voice and data communication. For example, the communication unit 502 receives at least one content and supplementary information about the content from a first set of electronic device, and transmits updated supplementary information to the first set of electronic device.

The storage unit 503 may include a programs storage unit storing a program for controlling an operation of the server and a data storage unit storing data generated during the execution of the program.

In the aforementioned block implementation, the control unit 501 can perform the general function of the server. Separately implementing and illustrating these are for distinguishing and describing respective functions. Accordingly, when product is actually implemented, the product can be implemented such that the control unit 501 processes all of the functions of the electronic device, or can be implemented such that the control unit 501 processes some of the functions.

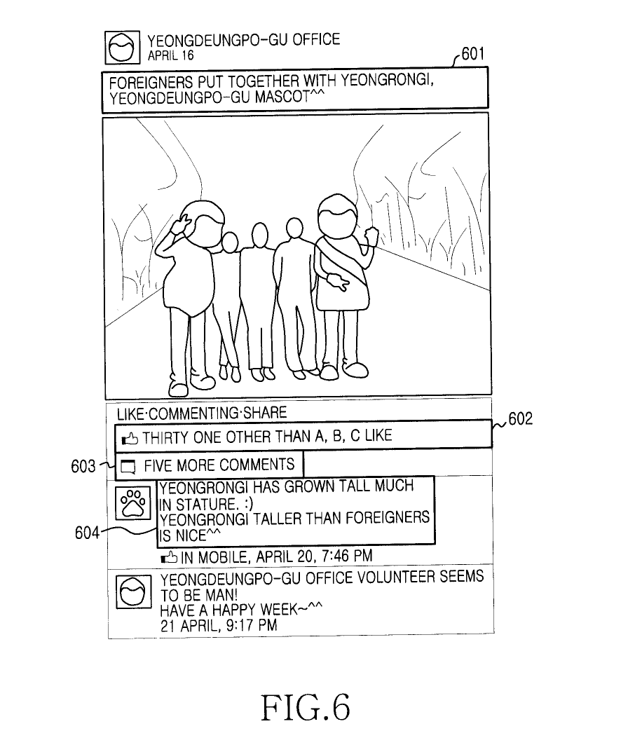

FIG. 6 is a diagram illustrating one example embodiment of extracting a second information (or a subset information) of a particular piece of content or a content item (such as a photo uploaded to a social media website) based on a first set of information received from a server (such as the social media server) in an electronic device according to the present disclosure. First, the electronic device can receive a first set of information about at least one content item from the server. Here, the first set information can be social media information, such as the number of times of recommendation of the content, the number of times of sharing, the number of times of comment, a set keyword among comment content, the number of times of additional information request, or the number of times of additional information provision.

This additional information may be considered “supplemental” to the content item. Accordingly, the electronic device can receive updates of the supplementary information about any uploaded content items from the server, such as the number of shares of a photo uploaded to a social media website. More specifically, the electronic device can receive information that a third party updates for posted information regarding the contents uploaded to the server (such as comments made by other users to a photo on the social media website). The updates may be made periodically according to a set time or schedule, or they may be received from the server when it is confirmed that the supplementary information has been updated.

The electronic device can extract a second “subset” of information about the content based on the received first set information. Here, the second subset of information can be, for example, social media information regarding the number of times of recommendation of the content, the number of times of sharing, the number of times of comment, a set keyword among comment content, the number of times of additional information request, or the number of times of additional information provision extracted from the first set of information is expressed in a metadata form. That is, the electronic device can extract updated supplementary information about the content in the metadata form based on the first set of information received from the server. A method of extracting the second subset of information about the content based on the received first set of information in the electronic device is described below in detail.

First, the electronic device can compare the received first set of information and the original supplementary information that was uploaded together with the content item when the content item was initially uploaded to the server. That is, the electronic device can compare the supplementary information about the content first uploaded to the server and the first set of information received from the server. After that, the electronic device may detect whether the data capacity of the first set of information is greater than a data capacity of the supplementary information about the content first uploaded to the server, which may indicate that updates have been made to the supplementary information after the content item was uploaded to the server (such as shares, comments or recommendations of a photo on a social media website).

If it is determined that the data capacity of the first set of information is greater than the data capacity of the supplementary information in the electronic device, the electronic device can confirm the presence of at least one piece of information such as the number of times of recommendation of content, the number of times of sharing, the number of times of comment, a set keyword among comment content, the number of times of additional information request, or the number of times of additional information provision extracted from the first set of information. After that, the electronic device can extract the confirmed at least one information in a metadata form.

For example, as illustrated in FIG. 6, after uploading a captured image and a corresponding comment or description (601) (which may, for example, describe the image), the electronic device may receive updated information regarding uploaded posts and comments from the server. The electronic device may then extract in a metadata form a number of times the image was recommended (602), which appears in the present example as “Thirty one other than A, B, and C like”, the number (603) of comments such as “Five more comments”, or content of one or more comments (604) such as “Yeongrongi has grown tall much in stature. Yeongrongi taller than foreigners is nice”. The electronic device can extract even the set keyword among the comment content in the metadata form. That is, the electronic device may extract a set keyword such as “̂̂” expressing human's emotion among the comment content, in the metadata form.

After that, the electronic device can store the data extracted in the metadata form together with contents, and use metadata stored in the contents when classifying the contents.

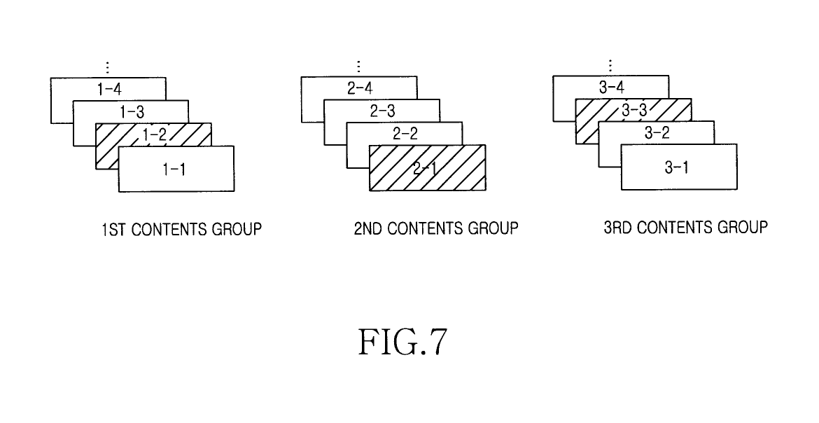

FIG. 7 is a diagram illustrating one example embodiment of classifying contents in accordance to a set reference based on an extracted second subset of information in an electronic device according to the present disclosure. First, the electronic device can store in contents the subset of information extracted in a metadata form and then, confirm the subset of information stored in the contents.

After that, the electronic device can classify the content items into, for example, a content items group. Such groups may be used to store content items having some characteristic with a similarity equal to or greater than set information threshold. For example, the electronic device may store in a common group content items having community in location information indicating where the content item was photographed, or time information indicating when the content item was photographed. Because of the commonality in these factors, various content items may thus be stored in a single content group.

In the aforementioned example, the electronic device can confirm the subset of information stored in the contents, and classify content items into a single content item group when the content items have a sufficiently similar location and time information.

Next, after storing the content items into the specific content item group, the electronic device can detect particular content item of the group to be representative for the entire content item group. The electronic device may select one such content item by detecting which content item possesses a second subset of information that is equal to or greater than a predetermined quantity. That is, the electronic device can detect which content item has a greater number of recommendations, the number of times of sharing, the number of times of comment, a set keyword among comment content, the number of times of additional information request, and the number of times of additional information provision. Whichever content item has more frequent updates or a quantity of information greater than a predetermined threshold may be selected from among the classified plurality of content items as representative for the content item group.

For another example, the electronic device may detect contents of which the subset of information is updated during a set time. That is, the electronic device can detect contents whose at least one information among the number of times the content received as recommendation, the number of times of sharing, the number of times of comment, a set keyword among comment content, the number of times of additional information request, and the number of times of additional information provision. The electronic device can determine whether any of these factors was updated a number of times equal to or greater than a preset quantity among the classified plurality of contents.

After that, the electronic device can choose the detected contents as a representative content of a content item group in which contents are stored. That is, the electronic device can detect contents of which the second subset of information is updated equal to or greater than the set capacity among the classified plurality of contents, and choose the detected contents as the representative contents of the contents group in which the contents are stored.

For example, as illustrated in FIG. 7, the electronic device can classify a plurality of contents stored in the electronic device into a first set of contents group to a 3^{rd} contents group in accordance to a set reference and store the classified plurality of contents and then, choose “1-2 contents”, “2-1 contents”, and “3-3 contents” of which the second subset of information are updated equal to or greater than the set capacity as representative contents of the respective contents groups.

After that, the electronic device may extract and manage the contents chosen as the representative contents, respectively, or may delete the remnant contents excepting the contents chosen as the representative contents to secure a storage space.

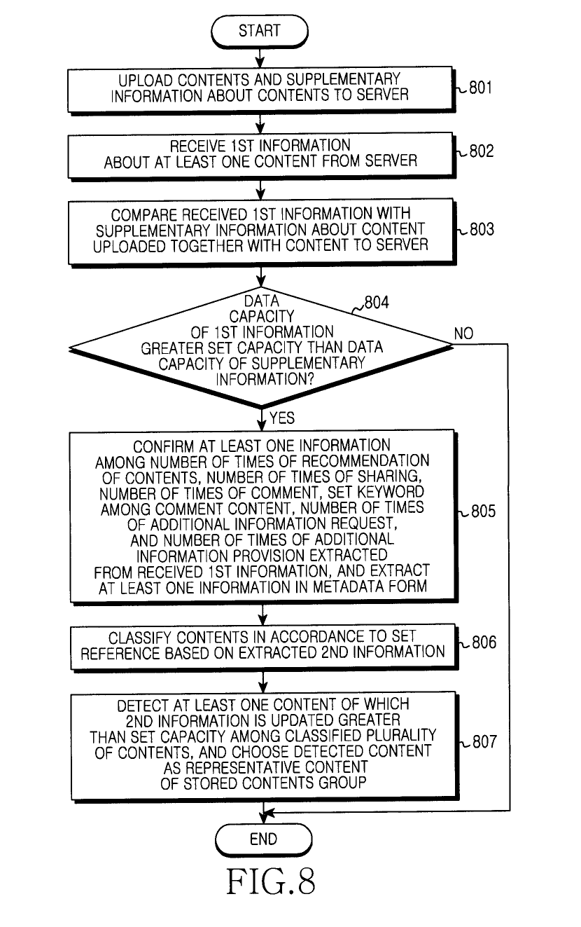

FIG. 8 is a flowchart illustrating an operation method of an electronic device of classifying contents using updated post information according to one example embodiment of the present disclosure. First, as illustrated in FIG. 8, the electronic device can upload contents and supplementary information about the contents to a server (step 801). For example, the electronic device can upload an image stored in the electronic device and writings stating the content of the image, to the server.

After that, the electronic device can receive first set of information about at least one content item from the server (step 802). Here, the first set of information can be social media information such as the number of times of recommendation of the content, the number of times of sharing, the number of times of comment, comment content, the number of times of additional information request, and the number of times of additional information provision. That is, the electronic device can receive updated information of supplementary information about contents uploaded to the server, from the server. More specifically, the electronic device can receive information that a third party updates for posted information regarding the contents uploaded to the server, periodically every set time, or can receive the updated information from the server when the updating is confirmed.

Next, the electronic device can compare the received first set of information with the supplementary information about the contents uploaded together with the contents to the server (step 803). Here, the second subset of information may be social media information such as the number of times of recommendation of the content, the number of times of sharing, the number of times of comment, a set keyword among comment content, the number of times of additional information request, or the number of times of additional information provision extracted from the first set of information is expressed in a metadata form.

After that, the electronic device can determine if a data capacity of the first set of information is equal to or is greater a set capacity than a data capacity of the supplementary information (step 804). That is, the electronic device can compare the data capacity of the supplementary information first uploaded to the server with the data capacity of the first set of information for which the supplementary information is updated, and determine if the data capacity of the first set of information is equal to or is greater the set capacity than the data capacity of the supplementary information. Here, although the above description is made in which the electronic device can determine that the data capacity of the first set of information is equal to or is greater the set capacity than the data capacity of the supplementary information, the electronic device may update the received first set of information irrespective of a capacity, every set time or in response to a user's input.

If the electronic device determines that the data capacity of the first set of information is greater than the data capacity of the supplementary information in the aforementioned determination process (step 804), the electronic device can confirm at least one information among the number of times of recommendation of contents, the number of times of sharing, the number of times of comment, a set keyword among comment content, the number of times of additional information request, and the number of times of additional information provision extracted from the received first set of information, and can extract the confirmed at least one information in a metadata form (step 805). Here, the electronic device can extract even the set keyword among the comment content in the metadata form. That is, the electronic device may extract a set keyword expressing human's emotion among the comment content, in the metadata form.

After that, the electronic device can classify the contents in accordance to a set reference based on the extracted second subset of information (step 806). For example, the electronic device can classify the contents into any one content group including content of similarity equal to or greater than set information with the second subset of information stored in the contents among a plurality of contents groups. For example, the electronic device sets to store contents whose place information where contents are photographed, time information at which the contents are photographed and the like are similar with one another among the contents stored in the electronic device, in one contents group. In the aforementioned example, the electronic device can confirm the second subset of information stored in the contents, and classify the contents into a contents group whose place information where the contents are photographed and time information at which the contents are photographed are similar with one another.

After that, the electronic device can detect at least one content of which the second subset of information is updated equal to or greater than a set capacity among the classified plurality of contents, and choose the detected content as representative content of the stored contents group (step 807). That is, the electronic device can detect contents whose at least one information among the number of times of recommendation of contents, the number of times of sharing, the number of times of comment, a set keyword among comment content, the number of times of additional information request, and the number of times of additional information provision is updated equal to or greater than the set capacity among the classified plurality of contents. After that, the electronic device can choose the detected contents as representative contents of a contents group in which contents are stored. That is, the electronic device can detect contents of which the second subset of information is updated equal to or greater than the set capacity among the classified plurality of contents, and choose the detected contents as the representative contents of the contents group in which the contents are stored. Here, the electronic device may detect contents having the largest amount of the second subset of information, and choose the detected contents as representative contents of a contents group in which contents are stored.

If the electronic device determines that the data capacity of the first set of information is not greater the set capacity than the data capacity of the supplementary information in the aforementioned determination process (804), the electronic device can just terminate the operation method.

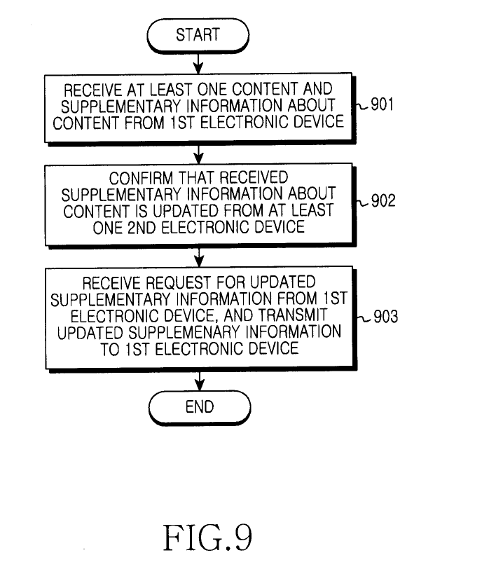

FIG. 9 is a flowchart illustrating an operation method of a server according to one example embodiment of the present disclosure. First, as illustrated in FIG. 9, the server can receive at least one content and supplementary information about the content from a first set of electronic device (step 901). For example, the server can receive a video and writings stating the content of the video from the first set of electronic device.

After that, the server can confirm that the supplementary information about the received content is updated from at least one second subset of electronic device (step 902). For example, the server can confirm that the second subset of electronic device does recommendation, does sharing, posts a comment, and requests additional information regarding the contents that the first set of electronic device has uploaded.

Next, the server can receive a request for updated supplementary information from the first set of electronic device, and transmit the updated supplementary information to the first set of electronic device (step 903). In detail, the server can transmit information that a third party updates for posted information regarding the contents received from the first set of electronic device, periodically every set time, or can transmit the updated information upon receiving a request from the first set of electronic device.

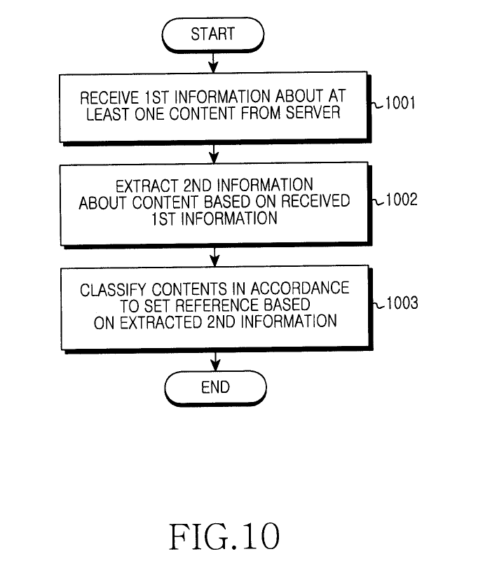

FIG. 10 is a flowchart illustrating a method of an electronic device according to one example embodiment of the present disclosure. Firstly, as illustrated in FIG. 10, the electronic device can receive first set of information about at least one content from a server (step 1001). In detail, the electronic device can receive information that a third party updates for posted information regarding the contents uploaded to the server, periodically every set time, or can receive the updated information from the server when the updating is confirmed.

After that, the electronic device can extract second subset of information about the content based on the received first set of information (step 1002). That is, the electronic device can extract updated supplementary information about the content in a metadata form based on the first set of information received from the server.

Next, the electronic device can classify the contents in accordance to a set reference based on the extracted second subset of information (1003). First, the electronic device can classify the contents into any one contents group storing contents of similarity equal to or greater than set information with the second subset of information stored in the contents among a plurality of contents groups. Next, after storing the contents classified into the specific contents group in the corresponding contents group, the electronic device can detect contents of which the second subset of information is updated equal to or more than a set capacity. After that, the electronic device can choose the detected contents as representative contents of a contents group in which contents are stored.

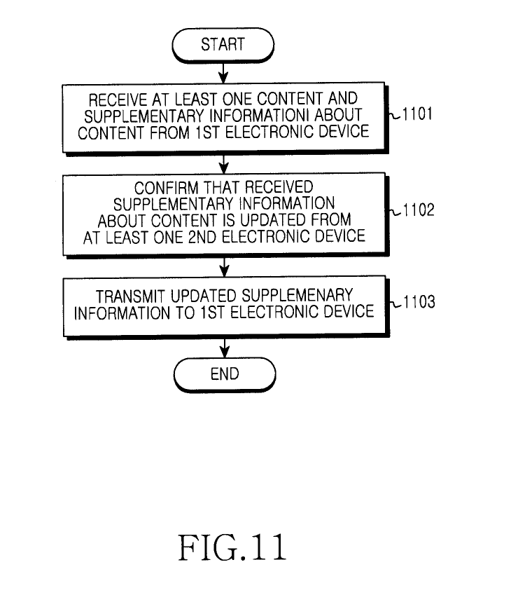

FIG. 11 is a flowchart illustrating a method of a server according to one example embodiment of the present disclosure. First, as illustrated in FIG. 11, the server can receive at least one content and supplementary information about the content from a first set of electronic device (step 1101). That is, the server can receive a post to be shared with a third party through a Social Networking Service (SNS) from the first set of electronic device.

After that, the server can confirm that the received supplementary information about the content is updated from at least one second subset of electronic device (step 1102). For example, the server can confirm that the second subset of electronic device does recommendation, does sharing, posts a comment, and requests additional information regarding the contents that the first set of electronic device has uploaded.

After that, the server can transmit the updated supplementary information to the first set of electronic device. In detail, the server can transmit information that a third party updates for posted information regarding the contents received from the first set of electronic device, periodically every set time, or can transmit the updated information upon receiving a request from the first set of electronic device.

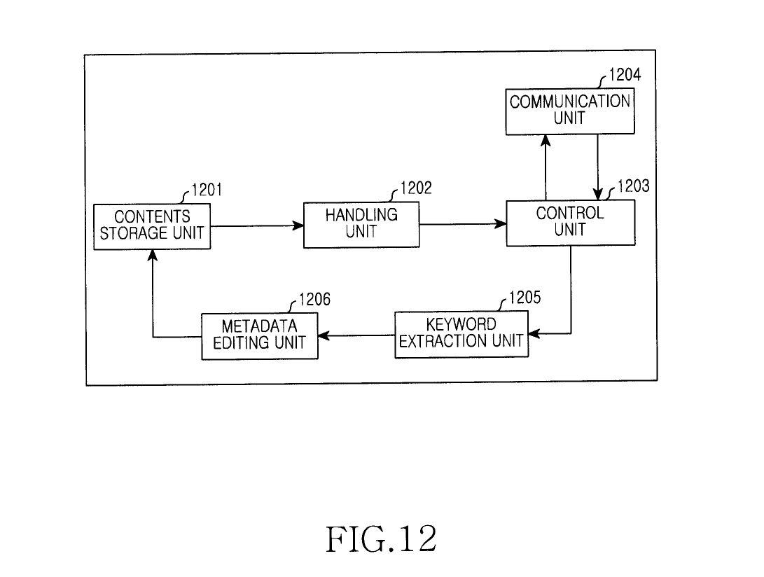

FIG. 12 is a diagram schematically illustrating an implementation of an electronic device according to one example embodiment of the present disclosure. As illustrated in FIG. 12, the electronic device according to the present disclosure can include a contents storage unit 1201, a handling unit 1202, a control unit 1203, a communication unit 1204, a keyword extraction unit 1205, and a metadata editing unit 1206.

First, the contents storage unit 1201 stores the original contents to be shared with a third party and tag information. In detail, the contents storage unit 1201 stores an image and video to be shared with the third party. Each of the image and video includes tag information, respectively. For example, the respective contents stored in the contents storage unit 1201 include place information, time information and the like of those times when the contents are photographed.

The handling unit 1202 can select at least one content among a plurality of contents stored in the contents storage unit 1201 in accordance to user's selection, and receive an input of a composition of posts related with the selected content, and receive an input of an instruction of uploading the composed posts to a specific server.

The control unit 1203 confirms content selected by the handling unit 1202 and a server to upload the selected content, and transmits the selected content and user information to the communication unit 1204, and controls the communication unit 1204 to receive updated information about posts.

The communication unit 1204 accesses the server providing a sharing service, and transmits data provided by the control unit 1203 to the server, and receives provided data from the server.

The keyword extraction unit 1205 extracts set data from updated post information provided by the server, and converts the extracted data into a form suitable to a keyword.

The metadata editing unit 1206 generates and stores a keyword extracted from the keyword extraction unit 1205 in tag information of designated contents.

In the aforementioned block implementation, the control unit 1203 can perform the general function of the electronic device. Separately implementing and illustrating these are for distinguishing and describing respective functions. Accordingly, when product is actually implemented, the product can be implemented such that the control unit 1203 processes all of the functions of the electronic device, or can be implemented such that the control unit 1203 processes some of the functions.

While the disclosure has been shown and described with reference to certain example embodiments thereof, it will be understood by those skilled in the art that various changes in form and details may be made therein without departing from the ambit of the disclosure as defined by the appended claims.

It will be appreciated that embodiments of the present disclosure according to the claims and description in the specification can be realized in the form of hardware, software or a combination of hardware and software. The functions and process steps herein may be performed automatically or wholly or partially in response to user command. An activity (including a step) performed automatically is performed in response to executable instruction or device operation without user direct initiation of the activity. The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Any such software may be stored in a computer readable storage medium. The computer readable storage medium stores one or more programs (software modules), the one or more programs including instructions, which when executed by one or more processors in an electronic device, cause the electronic device to perform a method of the present disclosure.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs including instructions that, when executed, implement embodiments of the present disclosure.

Accordingly, embodiments provide a program including code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

What is claimed is:

1. A method in an electronic device, the method comprising:
uploading to a server at least one content item;
receiving from the server a set of information associated with the at least one content item;
extracting a subset of information associated with the at least one content item from the set of information, the subset including at least one reference value; and
classifying the at least one content item with other content items when the at least one reference value correlates with reference values of the other content items

2. The method of claim 1, wherein uploading the at least one content item further comprises uploading supplementary information associated with the at least one content item to the server.

3. The method of claim 1, wherein the set of information comprises social media information, including at least one of:
a number of times the at least one content item is recommended,
a number of times the at least one content item is shared,
a number of times the at least one content item is commented on,
an indicator that a pre-set keyword is present in at least one comment associated with the at least one content item,
an indicator that a pre-set string indicating a human emotion is present in at least one comment associated with the at least one content item,
a number of times the at least one content item is subject to an additional information request, and
a number of times that the at least one content item is subject to provision of additional information.

4. The method of claim 1, wherein the subset comprises social media information that is at least one of:
a number of times the at least one content item is recommended,
a number of times the at least one content item is shared,
a number of times the at least one content item is commented on,
an indicator that a pre-set keyword is present in at least one comment associated with the at least one content item,
an indicator that a pre-set string indicating a human emotion is present in at least one comment associated with the at least one content item,
a number of times the at least one content item is subject to an additional information request, and
a number of times that the at least one content item is subject to provision of additional information,
wherein the subset is extracted from the set of information and is stored in a metadata format.

5. The method of claim 2, wherein the extracting the subset from the set further comprises:
updating the received set regularly in accordance with an update interval, or in response to detection of an input indicating update should be performed;
confirming the at least one category information of the subset; and
extracting the confirmed at least one category of information from the subset in a metadata format.

6. The method of claim 1, wherein classifying the at least one content item further comprises:
storing the extracted subset in respective fields of the at least one content item; and
a reference value of the subset correlates with a second reference value of information associated with the other content items when the reference value and the second reference have a similarly equal to or greater than a predetermined value.

7. The method of claim 6, further comprising storing the classified at least one content item and the other content items in a content item group.

8. The method of claim 1, wherein classifying the at least one content item with the other content items further comprises:
storing the classified at least one content item and the other content items as a content item group;
detecting a particular content item having a largest subset of information among the classified at least one content item and the other content items; and
selecting the detected particular content item as a representative content item for the content item group.

9. A method executable on a server, the method comprising:
receiving upload of at least one content item and supplementary information about the content item from a first electronic device;
receiving an update of the received supplementary information from at least one second electronic device; and
transmitting the updated supplementary information to the first electronic device,
wherein the first electronic device is configured to extract a subset of information from the updated supplementary information, and classify the at least one content item with other content items stored on the first electronic device when at least one reference value of the subset correlates with reference values of the other content items.

10. The method of claim 9, wherein the updated supplementary information includes social media information comprising at least one of:
a number of times the at least one content item is recommended,
a number of times the at least one content item is shared,
a number of times the at least one content item is commented on,
an indicator that a pre-set keyword is present in at least one comment associated with the at least one content item,
a number of times the at least one content item is subject to an additional information request, and
a number of times that the at least one content item is subject to provision of additional information.

11. An electronic device comprising:
a communication module configured to:
upload to a server at least one content item, and
receive from the server a set of information about at least one content item from a server; and
a processor configured to:
extract a subset of information associated with the at least one content item from the set of information, the subset including at least one reference value, and
classify the at least one content item with other content items when the at least one reference value correlates with reference values of the other content items.

12. The device of claim 11, wherein uploading the at least one content item further comprises uploading supplementary information associated with the at least one content item to the server.

13. The device of claim 11, wherein the set of information comprises social media information, including at least one of:
a number of times the at least one content item is recommended,
a number of times the at least one content item is shared,
a number of times the at least one content item is commented on,
an indicator that a pre-set keyword is present in at least one comment associated with the at least one content item,
an indicator that a pre-set string indicating a human emotion is present in at least one comment associated with the at least one content item,
a number of times the at least one content item is subject to an additional information request, and
a number of times that the at least one content item is subject to provision of additional information.

14. The device of claim 11, wherein the subset comprises social media information that is at least one of:
a number of times the at least one content item is recommended,
a number of times the at least one content item is shared,
a number of times the at least one content item is commented on,
an indicator that a pre-set keyword is present in at least one comment associated with the at least one content item,
an indicator that a pre-set string indicating a human emotion is present in at least one comment associated with the at least one content item,
a number of times the at least one content item is subject to an additional information request, and
a number of times that the at least one content item is subject to provision of additional information,
wherein the subset is extracted from the set of information and is stored in a metadata format.

15. The device of claim 11, wherein the processor is further configured to
update the received set regularly in accordance with an update interval, or in response to detection of an input indicating update should be performed;
confirm the at least one category information within the subset; and
extract the confirmed at least one category of information from the subset in a metadata format.

16. The device of claim 11, wherein classifying the at least one content item further comprises storing the extracted subset in respective fields of the at least one content item; and
a reference value of the subset correlates with a second reference value of information associated with the other content items when the reference value and the second reference have a similarly equal to or greater than a predetermined value.

17. The device of claim 16, wherein the processor is further configured to store the classified at least one content item and the other content items in a content item group

18. The device of claim 11, wherein the processor is further configured to:
store the classified at least one content item and the other content items as a content item group;
detect a particular content item having a largest subset of information among the classified at least one content item and the other content items; and
select the detected particular content item as a representative content item for the content item group.

19. A server comprising:
a communication unit; and
a processor, configured to:
receive, via the communication unit, upload of at least one content item and supplementary information about the content item from a first electronic device;
receive, via the communication unit, an update of the received supplementary information from at least one second electronic device; and
transmit, via the communication unit, the updated supplementary information to the first electronic device,
wherein the first electronic device is configured to extract a subset of information from the updated supplementary information, and classify the at least one content item with other content items stored on the first electronic device when at least one reference value of the subset correlates with reference values of the other content items.

20. The server of claim 19, wherein the updated supplementary information includes social media information comprising at least one of:
a number of times the at least one content item is recommended,
a number of times the at least one content item is shared,
a number of times the at least one content item is commented on,
an indicator that a pre-set keyword is present in at least one comment associated with the at least one content item,
a number of times the at least one content item is subject to an additional information request, and
a number of times that the at least one content item is subject to provision of additional information.
